(19) United States
(12) Patent Application Publication
(10) Pub. No.: US 2020/0055615 A1
(43) Pub. Date: Feb. 20, 2020

(54) METHOD AND APPARATUS FOR REMOVING COATINGS

(71) Applicant: AEROMET TECHNOLOGY SOLUTIONS, LLC, Cleveland, TX (US)

(72) Inventor: David C. FAIRBOURN, Sandy, UT (US)

(73) Assignee: AEROMET TECHNOLOGY SOLUTIONS, LLC, Cleveland, TX (US)

(21) Appl. No.: 16/478,834

(22) PCT Filed: Apr. 2, 2018
(86) PCT No.: PCT/US2018/025771

§ 371 Date: Jul. 17, 2019

Related U.S. Application Data
(60) Provisional application No. 62/453,006, filed on Feb. 1, 2017.

(51) Int. Cl. B64F 5/40; B23K 1/20; B23K 1/00; C25F 1/04; C25F 7/00

(52) U.S. Cl. CPC B64F 5/40; B23K 1/20; B23K 2101/001; C25F 1/04; C25F 7/00; B23K 1/0018

(57) ABSTRACT

A method and apparatus for removing a coating from a gas turbine engine component enabling repair of the component, including application of a braze alloy, without fluoride ion cleaning uses electrolytic stripping of the component in an alkaline bath with the component acting as an anode and current passing to a conformal cathode.

### TECHNICAL FIELD

The present invention is directed to processes and apparatus for removing coatings from gas turbine engine components.

### BACKGROUND

A typical gas turbine engine includes a compressor section with shaft mounted blades for compressing air that is then directed into a combustor where fuel is mixed with the air and ignited, the heated gases then expanding through a high-pressure turbine (HPT) which includes stationary vanes and rotating turbine blades mounted on the same shaft driving the compressor, and then through a low pressure turbine (LPT) with blades mounted on a second shaft which drives a fan to provide thrust in the case of an aircraft jet engine, or drives an electrical generator in the case of a power generating industrial gas turbine engine (IGT). The HPT and LPT blades (“buckets” in IGT) are circumscribed by shrouds (“tiles” in IGT) to form the flowpath for the working gas. The efficiency of any gas turbine engine is enhanced by reaching higher temperatures. Components of gas turbine engines thus exposed to high temperature environments are conventionally manufactured from nickel-, cobalt-, or iron-based superalloy materials which exhibit improved mechanical properties at high operating temperatures. The operating environment leads to three types of degradation limiting the component's useful life; hot corrosion, stress corrosion cracking (also generally referred to as Type I and Type II corrosion, respectively, and as sulfidation), and high temperature oxidation. The temperature ranges at which Type I and Type II corrosion, and High Temperature Oxidation, degrade the superalloy depends on the superalloy composition.

The ability to achieve even higher engine operating temperatures has been enabled through the use of coatings on superalloy components. Coatings can be used either alone as an environmental coating (to protect the component, also referred to hereinafter as a part, directly from corrosion or oxidation) or as a bond coat for a subsequently applied thermal barrier coating (TBC), such as Yttria stabilized zirconia (YSZ) applied to surfaces exposed to hot gases, particularly flowpath surfaces. Exemplary superalloy coatings include MCrAlY (where M represent one or more of Fe, Co, and Ni), platinum aluminides, and nickel aluminides, each of which provide a source of aluminum to form and replenish a thermally grown oxide (TGO) layer of alumina (Al₂O₃) on their surface when exposed to oxygen at high temperatures, the alumina providing an effective protection against high temperature oxidation. Other coatings, such as wear coatings or abradable coatings, may also be applied on components, such as Chromium Carbide—Nickel Chromium (CrC—NiCr). Over time, however, high temperature oxidation and hot corrosion, may form corrosive deposits which attack and degrade the protective oxide scale. In particular, conventional IGTs operate for long periods of time at a constant high temperature resulting in type I and type II corrosion. Whatever the source, coatings and base material of gas turbine engine components experience degradation which may be repairable in order to return these high-value parts to service.

As shown in FIG. 1, a cross-section of a gas turbine engine component 10 has a coating 12 on a substrate 14 with cracks 16 extending from the surface 18 of the coating 12, some of which may extend beyond the substrate surface 20 into the substrate 14. Once initiated, oxides 22 tend to form as deposits on the crack surfaces 24 as it has been determined that it is a natural phenomena for atomic species in the coatings to migrate and move into the cracks to self help a repair (eventually overwhelmed as the crack widens) ultimately developing a spinel form of deposit, hereinafter referred to as a spinel 26. In this context, a spinel is a metallurgical form of the molecule having three elements, here the chemistry of the individual molecule is M₁M₂O_{X}. In the case of CoCrAlY's the elements are typically Cobalt, Chromium and an Oxygen. Silicon may be substituted occasionally. The source of silicon is from the environment. Sulfur can also be substituted for the oxygen, the Source of sulfur is a contaminant in the fuel and minor amounts of environmental sulfur. Sulfur reacts in the same manner as oxygen. Sulfur is particularly damaging since there is an affinity between sulfur and nickel. The resulting damage from this is called sulfidation. Once the spinels deposit on the crack walls, they are tenacious and prevent good bonding of a braze or weld to the parent metal necessary for an effective repair.

In order to repair such engine components, they are removed from the engine for a repair process which includes cleansing all contaminants from the base material and restoring the components to an operable condition. In order to do this, as depicted schematically in FIG. 3, coatings are stripped from the component either by chemical removal through immersion in an acidic bath to dissolve the coating or by mechanically removing the coating such as by grit blasting. In either case the components require further cleaning to ensure all contaminants, particularly spinels, are removed from any cracks in the substrate surface to ensure subsequent application of a braze alloy or welding to heal such cracks will be successful. In order to ensure complete removal of all contaminants the components have been subjected to a fluoride ion cleaning (FIC) process, such as one taught in U.S. Pat. No. 4,098,450, to achieve a clean condition as shown in FIG. 2, prior to application of braze material to fill any cracks.

Airfoils are involved in repair operations, including blades (or buckets) and vanes (or nozzles), which may be cast using equiax, directional solidification, or single crystal methods depending on the superalloy. Items like transition ducts, liners, combustors (including combustor liners and fuel nozzles) and end caps have also been involved in repair operations. One component subject to repair is a tile (functionally the same as a shroud in aero engines). In the past the repair method included immersion in acid to dissolve the coating, followed by FIC to remove the deposits that developed in the cracks during engine operation. Original manufacture of these components typically involved casting using equiax methods.

Two exemplary parts, shrouds (or tiles), and vanes (or nozzles) are both subject to cyclic fatigue cracks in the corners and filet radii, or just in general on a tile or shroud. Repair requires coatings be stripped from the parts which are then subjected to FIC to remove the deposits. Repair alloys are then applied to the parts to heal the cracks, such as GE's Activated Diffusion Healing (ADH) alloy and Partitioned Alloy Component Healing (PACH) alloy. See e.g., U.S. Pat. No. 4,830,934.

Tiles or shrouds have been attacked by the acids used in the chemical stripping such that it has become a standard trade practice to only grit blast the coatings off, followed by FIC.

FIC also has some peculiar shortcomings, especially when it comes to chromium rich either substrates or coatings, or spinels. Chromium has been observed on occasion to react during FIC becoming like a coating and depositing on the FIC chamber such that parts were coated rather than cleaned. It has been reported that cobalt based substrate IGT components with CoCrAlY's as a coating must be run either twice or three times through the FIC to fully remove the spinels. Occasionally the FIC's themselves must be cleaned out by running empty heat cycles.

Based on the issues discussed above, there is a need for improving the process to economically clean coatings from components used in gas turbine engines, particularly cobalt based substrates and CoCrAlY coatings and nickel based substrates with MCrAlY coatings.

### SUMMARY

A method for removing a coating from a gas turbine engine component is provided, including the steps of providing a bath with a conformal cathode and electrolyte solution, placing the component in the bath and connecting a power source to the component such that it will act as an anode, and agitating the solution while passing an electric current between the components and the cathode to electrolytically remove the coating and spinels that may have formed in stress corrosion cracks in the substrate. The components can then be removed from the bath, rinsed, and optionally undergo a high temperature, hot vacuum cycle in a heat treat furnace and have a braze alloy applied to the cracks without requiring an intervening fluoride ion cleaning cycle. The electrolyte solution has a pH that is basic and can have a chemical composition including one or more of sodium citrate, sodium percarbonate, sodium bicarbonate, and sodium phosphate. The electric current can be supplied by a rectifier 42 capable of providing up to 4000 A at no more than 5 V, the amperage actually supplied calculated based on the surface area to be cleaned. The conformal cathode is made from an electrically conductive material, having a high incipient melting point and which is inert when immersed in a solution having a pH in a range of about 9 to 11. The electrolyte solution is heated to maintain a temperature between about 48° C. to about 75° C. The components has a cobalt base substrate and/or a cobalt containing coating such as CoCrAlY or a CrC—NiCr coating.

Apparatus for use in performing the method are described, including a bath holding electrolyte solution, a conformal cathode in the shape to enable electrolytic stripping of the component, a heater for controlling the temperature of the solution, a rectifier for providing a direct current between the component as an anode and the conformal cathode, and an agitator for agitating the solution. The rectifier 42 is capable of providing up to 4000 A while controlling the voltage between 3.75 volts to 4.25 volts. The pH of the solution is alkaline or basic enabled by a chemical composition such as sodium citrate, sodium percarbonate, sodium bicarbonate, or sodium phosphate. The conformal cathode is made from an electrically conductive material that is inert when immersed in a solution having a pH in a range of about nine to about 11 and with the thickness capable of conducting 4000 A at about 4 V without loss of material. The agitator can be a direct in the tank agitation pump or an external pump flowing the solution into the tank, such as through a sparger flowing only liquid.

### BRIEF DESCRIPTION OF THE DRAWINGS

The accompanying drawings, which are incorporated in and constitute a part of this specification, illustrate embodiments of the invention and together with the detailed description given below, serve to explain various aspects of the invention.

FIG. 1 is a cross-sectional view of a portion of an engine run gas turbine engine component.

FIG. 2 shows the cross-section of FIG. 1 after having been cleaned of all coatings and contaminants within the cracks.

FIG. 3 is a block diagram of prior art steps used in a method to repair a gas turbine engine component.

FIG. 4 is a block diagram of steps in a repair method four gas turbine engine component.

FIG. 5 is a diagrammatic view of an apparatus for stripping the coating and cleaning contaminants from cracks of the gas turbine engine component of FIG. 1.

FIG. 6 is an isometric view of the apparatus of FIG. 5 along the line 6-6 in FIG. 5.

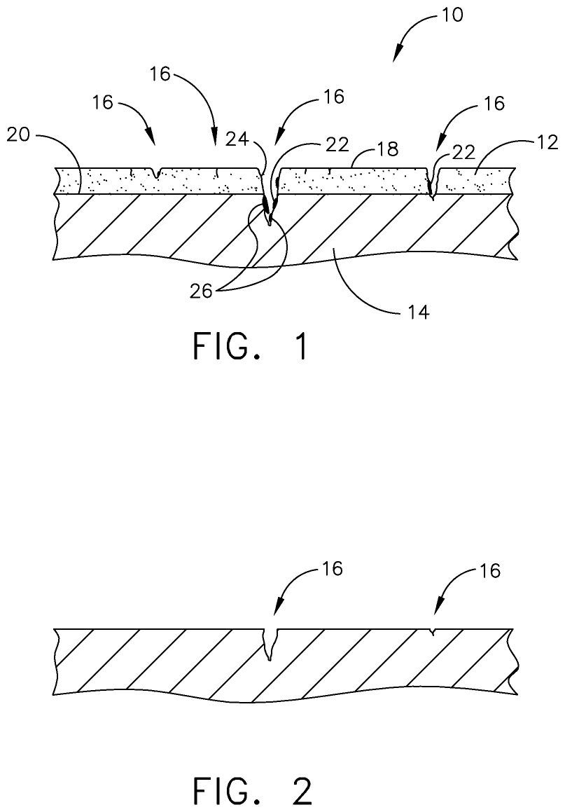

### DETAILED DESCRIPTION

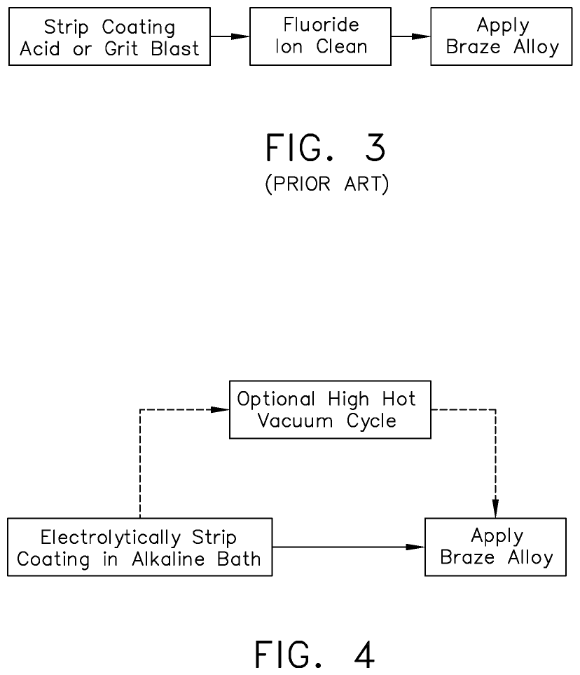

As previously discussed, FIG. 3 shows the steps used in a method to remove a coating 12 from a gas turbine engine component 10 and apply a braze alloy to complete a repair of the component as practiced in the prior art. The repair process includes removing the coating 12 by either a chemical stripping process or a mechanical process, such as grit blasting. Following removal of the coating, the component is subjected to FIC to further remove any oxides 22 and/or spinels prior to application of a braze alloy. The FIC is conventionally followed by at least one high hot vacuum cycle.

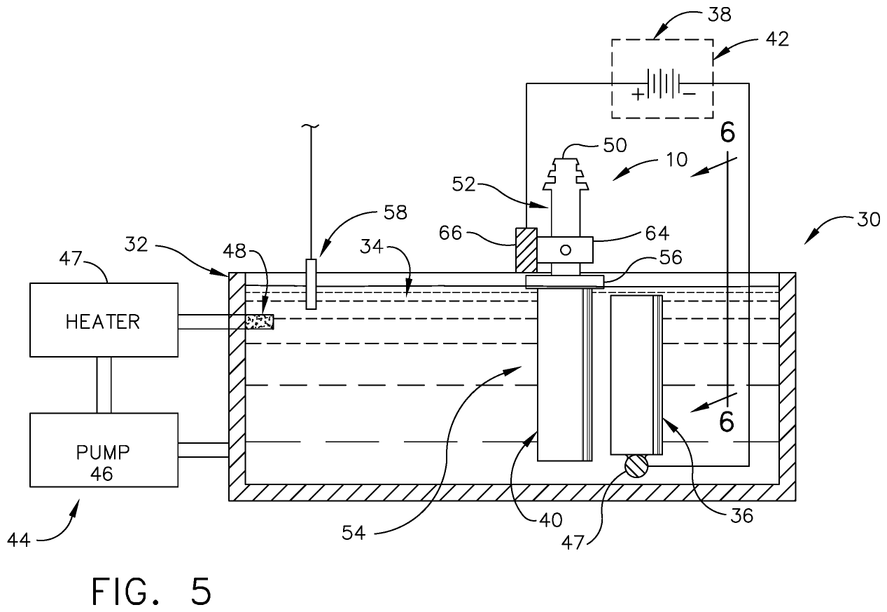

FIG. 4 shows the steps in the process presently claimed, including electrolytically stripping a coating followed by application of a braze alloy without use of FIC. Optionally, a high hot vacuum cycle may be used after the stripping step.

FIG. 5 shows an embodiment of an apparatus 30 for stripping a coating 12 and cleaning contaminants from cracks 16 of a gas turbine engine component 10, providing an exemplary example of a blade 50 mounted in the apparatus 30. Apparatus 30 includes a bath 32 containing an electrolyte solution 34 and within which a conformal cathode 36 is provided, electrically connected to the negative terminal of a power source 38 such that when a current is supplied to a gas turbine engine component 10 electrically connected to the positive terminal of the power source 38, the gas turbine engine component portion which is immersed in the electrolyte solution 34 will act as an anode 40. Apparatus 30 further includes a pump 46 to pump the electrolyte solution 34 through a heater 47, which is controlled by a thermocouple 58 in order to maintain a temperature of the electrolyte solution in the desired range, and in the embodiment shown returns the pumped electrolyte solution 34 into the bath 32 through an optional sparger 48. In the embodiment shown, the externally mounted pump 46 acts as an agitator 44 to provide a flow to the bath 32 agitating electrolyte solution 34 inside. In another embodiment pump 46 could be mounted inside the bath 32 to provide agitation to solution 34, as could heater 47. Flo King provides pumps that could be located within the bath 32.

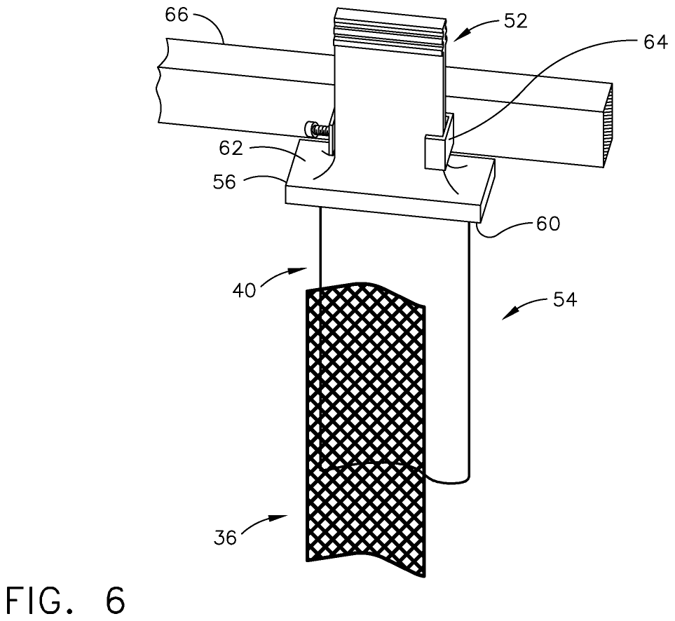

FIG. 6 provides an isometric view of the apparatus 30 of FIG. 5 taken along lines 6-6 in FIG. 5. In the exemplary embodiment shown of a blade 50 the blade route 52 is mounted on rail 66 by clamp 64 such that blade platform 56 has a non-flowpath portion 62 of the blade platform 56 remaining outside of the electrolyte solution 34 while a flowpath portion 60 of blade platform 56 can be in contact with electrolyte solution 34 along with airfoil portion 54 which is immersed totally in electrolyte solution 34. Gas turbine engine blades 50 are conventionally coated with at least an environmental coating on the flowpath portion 60 of blade platform 56 and airfoil portion 54 as these areas are exposed to hot flowpath gases during engine operation and thus most subject to degradation requiring removal of the coatings and cleansing of any cracks for repair purposes.

Tile/shroud samples from components that had been run in an engine and had stress corrosion cracks with spinels were tested using the method and apparatus described above. The substrate was a cobalt based superalloy, GE FSX414 having an environmental coating. Coatings were removed from a tile/shroud sample using a method including the steps of providing the bath with a conformal cathode and an electrolyte solution, placing the tile/shroud sample in the bath and electrically connecting tile/shroud sample to a rectifier power source which enabled the tile/shroud sample to act as an anode while passing an electric current through the solution between the tile/shroud sample and the conformal cathode. Surprisingly coatings were stripped so effectively that it was determined that it was not necessary to perform the conventional FIC cleaning prior to application of the braze alloy. The tiles came out of the stripping process clean enough that they could be brazed directly, although it may be advantageous to run the parts in a high hot vacuum cycle, like 1975° F. for two hours at a range of 10⁻⁴ or 10⁻⁵ Torr. Coming out of this cycle the braze can be applied directly to the part. The recipe for the chemical solution was ⅓rd molar sodium citrate and ⅓rd molar sodium percarbonate. The pH of the solution was around 9-10. Voltage was applied through the rectifier between the parts (as an anode) and a conformal cathode. This voltage was controlled to be around 4 volts and restricted so as to never permit it to exceed, five volts.

The conformal cathodes were made from SS 304. The thickness of these cathodes must be adequate to carrying the current load. In one bath a rectifier 42 capable of 4000 amperes was used, so the cathodes were large and thick to carry this current. While ability to carry such a high current would suggest copper being better than SS 304, copper is a metal which would deleteriously affect the substrate of the desired part or component by incipient melting and thus should not be used. Copper, silver or other such metals should be avoided for use as cathodes, and metals like titanium are not conductive enough and would need to be very thick to be effective.

The baths can be run from 48° C. as a standard but can be up to 75° C. Higher temperatures of the bath begins to drive off the percarbonate portion and the cost of the operation increases substantially.

It has been determined that the electrolyte solution must be agitated. In one embodiment, direct in the tank agitation can be accomplished by a pump such a Flo-King Pump. In another embodiment the solution can exit the tank for filtering the solution and reentering the tank via a sparger. Ventilation is not necessary.

When percarbonate is used, a portion of the molecule, that portion which is a peroxide ion is eventually consumed and driven off. The remainder of the molecule is a carbonate, really a carbon and a number of oxygens. When this occurs the chemical reaction will continue to work just at a slower rate.

There is some deep chemistry which is behind the excellent performance of this bath. First, Aluminum, yttrium and chromium can all be stripped in a solution wherein the pH is 9-10 regardless of the chemical method whereby it was contrived. Sodium hydroxide might therefore be an alternative except that it is very high pH. A typical 1 molar solution would be around pH 12. When such a solution was attempted in the same manner in a laboratory large holes developed in the substrate much more dramatically than typical Hydrochloric acid pitting. Therefore, gentle dilute basic solution like those proposed are the likely best candidate for this operation, with a preferred solution being generally basic and one embodiment having an electrolyte solution with a pH of between about 9 and about 12, and another embodiment with a pH of between about 9 and about 10. It has been determined acidic electrolytic solutions such as using oxalic acid would cause significant loss of substrate material when a current is applied. Alternative alkaline compositions such as sodium phosphate could be used. The electrolyte solution can be optimized based on the component materials and coatings involved, the current and the conformal cathode.

While the present invention has been illustrated by a description of various embodiments and while these embodiments have been described in some detail, it is not the intention of the inventor to restrict or in any way limit the scope of the appended claims to such detail. Thus, additional advantages and modifications will readily appear to those of ordinary skill in the art. The various features of the invention may be used alone or in any combination depending on the needs and preferences of the user.

1.-25. (canceled)

26. A method of removing a coating from an engine run gas turbine engine component, comprising a substrate and a coating on at least a portion of the substrate, the component having stress corrosion cracks including spinels in the substrate, the method comprising:
providing a bath with a conformal cathode and an electrolyte solution having a pH that is basic;
placing the component in the bath, wherein the component is electrically connected to a power source enabling the component to act as an anode;
agitating the solution while passing an electric current through the solution between the component and the conformal cathode effective to remove the coating from the substrate and to remove the spinels from the cracks.

27. The method of claim 26 further comprising:
removal of the component from the bath,
rinsing the component, and
application of a braze alloy to the cracks without use of fluoride ion cleaning to effect a repair to the stress corrosion cracks in the substrate.

28. The method of claim 26 wherein the gas turbine engine component is selected from the group consisting of vanes, nozzles, blades, buckets, combustion liners, transition ducts and end caps.

29. The method of claim 26 wherein the gas turbine engine component is selected from the group consisting of shrouds and tiles.

30. The method of claim 26 further comprising:
removing the component from the bath; and
subjecting the component to a high temperature, hot vacuum cycle in a heat treat furnace.

31. The method of claim 30 wherein the high hot vacuum cycle comprises a temperature of about 1975° F. for about two hours at a vacuum pressure range of 10⁻⁴ or 10⁻⁵ Torr.

32. A method of removing a coating from a gas turbine engine component, the component comprising a substrate and a coating on at least a portion of the substrate, the method comprising:
providing a bath with a conformal cathode and an electrolyte solution, wherein the electrolyte solution has a pH between about 9 and about 12;
placing the component in the bath, wherein the component is electrically connected to a power source enabling the component to act as an anode;
agitating the solution while passing an electric current through the solution between the component and the conformal cathode effective to remove the coating from the substrate.

33. The method of claim 26 wherein the pH of the electrolyte solution is between about 9 and about 10.

34. The method of claim 32 wherein the electrolyte solution has a chemical composition comprising at least one of sodium citrate, sodium percarbonate, sodium bicarbonate, and sodium phosphate.

35. The method of claim 34 wherein the electrolyte solution has a chemical composition comprising about one third molar sodium citrate and about one third molar sodium percarbonate.

36. The method of claim 26 wherein the power source is a rectifier with a voltage controlled to not exceed 5 volts.

37. The method of claim 36 wherein the electrical current is between 0 and 4000 amperes.

38. The method of claim 26 wherein the conformal cathode comprises an electrically conductive material having a which is inert when immersed in a solution with a pH in a range of about 9 to about 11.

39. The method of claim 26 wherein the temperature of the electrolyte solution is between about 48° C. to about 75° C.

40. The method of claim 26 wherein the component comprises at least one of a cobalt based substrate, a cobalt containing coating, a CoCrAlY, coating, and a CrCo—NiCr coating.

41. The method of claim 26 wherein the coating comprises at least one of the elements selected from the group consisting of cobalt, chromium, aluminum and yttrium.

42. Apparatus for enabling a stripping process to strip a coating from a gas turbine engine component comprising;
a bath holding an electrolyte solution that has a pH that is basic;
a conformal cathode placed in the bath and shaped to conform to the component being stripped; Page 7
means for heating the solution comprising a heater controlled by a thermocouple;
a rectifier for providing a direct current between the components acting as an anode when in the bath and the conformal cathode; and
an agitator for agitating the electrolyte solution during a stripping process.

43. The apparatus of claim 42 wherein:
the rectifier is capable of providing up to about 4000 A in a range of about 3.75 volts to 4.25 volts; and
the conformal cathode comprises an electrically conductive material which is inert when immersed in a solution with a pH in a range of about 9 to about 11 and is formed in a thickness capable of conducting up to about 4000 A in a range of about 3.75 volts to 4.25 volts without loss of material.

44. The apparatus of claim 42 wherein the electrolyte solution a chemical composition including at least one of sodium citrate, sodium percarbonate, sodium bicarbonate, and sodium phosphate.

45. The apparatus of claim 42 wherein the agitator is a pump selected from the group consisting of a direct in the tank agitation pump and an external pump for flowing the solution into the tank through a sparger.
